(19) United States
(12) Patent Application Publication
(10) Pub. No.: US 2011/0119993 A1
(43) Pub. Date: May 26, 2011

(54) HIGH SEVERITY HYDROPROCESSING INTERSTITIAL METAL HYDRIDE CATALYSTS AND ASSOCIATED PROCESSES

(75) Inventors: Faiz Pourarian, Wexford, PA (US); Marc A. Portnoff, Pittsburgh, PA (US); David A. Purta, Gibsonia, PA (US); Margaret A. Nasta, McKeesport, PA (US); Jingfeng Zhang, Gibsonia, PA (US)

(73) Assignee: EXXONMOBIL RESEARCH AND ENGINEERING COMPANY, Annandale, NJ (US)

(21) Appl. No.: 12/948,595

(22) Filed: Nov. 17, 2010

Related U.S. Application Data
(60) Provisional application No. 61/281,965, filed on Nov. 24, 2009.

(51) Int. Cl. C10L 1/00; B01J 21/06; B01J 21/08

(52) U.S. Cl. 44/307; 502/349; 502/308; 502/325; 502/337; 502/339; 502/338; 502/242

(57) ABSTRACT

The present invention relates to the processing of hydrocarbon-containing feedstreams in the presence of an interstitial metal hydride containing catalyst and hydrogen at process conditions of at least 400 psig pressure and temperatures of at least 200° C. These processes use interstitial metal hydrides that possess significant hydrogen capacities and high hydrogen kinetics rate properties. The catalysts and processes of the present invention may be used with or without radio frequency or microwave energy and are preferably run under conditions of high hydrogen partial pressure above about 350 psia. The catalysts and processes of the present invention can improve overall hydrogenation, product conversion, as well as sulfur reduction in hydrocarbon feedstreams as compared to processes of the prior art operated under similar conditions.

This application claims the benefit of U.S. Provisional Application No. 61/281,965 filed Nov. 24, 2009.

### FIELD OF THE INVENTION

The present invention relates to the processing of hydrocarbon-containing feedstreams in the presence of an interstitial metal hydride containing catalyst and hydrogen at process conditions at least 400 psig pressure and temperatures of at least 200° C. The process of the present invention includes improved interstitial metal hydride compositions for improved overall hydrogenation, product conversion, as well as sulfur reduction in hydrocarbon feedstreams.

### DESCRIPTION OF RELATED ART

As the demand for hydrocarbon-based fuels has increased, the need for improved processes for desulfurizing hydrocarbon feedstreams has increased as well as the need for increasing the conversion of the heavy portions of these feedstreams into more valuable, lighter fuel products. These hydrocarbon feedstreams include, but are not limited to, whole and reduced petroleum crudes, shale oils, coal liquids, atmospheric and vacuum residua, asphaltenes, deasphalted oils, cycle oils, FCC tower bottoms, gas oils, including atmospheric and vacuum gas oils and coker gas oils, light to heavy distillates including raw virgin distillates, hydrocrackates, hydrotreated oils, dewaxed oils, slack waxes, raffinates, biofuels, and mixtures thereof.

Hydrocarbon streams boiling above 430° F. (220° C.) often contain a considerable amount of large multi-ring hydrocarbon molecules and/or a conglomerated association of large molecules containing a large portion of the sulfur, nitrogen and metals present in the hydrocarbon stream. A significant portion of the sulfur contained in these heavy oils is in the form of heteroatoms in polycyclic aromatic molecules, comprised of sulfur compounds such as dibenzothiophenes, from which the sulfur is difficult to remove.

The high molecular weight, large multi-ring aromatic hydrocarbon molecules or associated heteroatom-containing (e.g., S, N, O) multi-ring hydrocarbon molecules in heavy oils are generally found in a solubility class of molecules termed as asphaltenes. A significant portion of the sulfur is contained within the structure of these asphaltenes or lower molecular weight polar molecules termed as “polars” or “resins”. Due to the large aromatic structures of the asphaltenes, the contained sulfur can be refractory in nature and can be difficult to remove. In conventional refining processes, sulfur compounds are removed in refinement processes from various hydrocarbon streams by “cracking” the petroleum oils in the presence of a metal catalyst and hydrogen. These conventional refining processes for sulfur removal from hydrocarbon streams, are known by such names as “hydrodesulfurization” processes or “hydrocracking” processes, are well known in the industry. In these catalytic processes, the sulfur-containing hydrocarbon streams are contacted with catalysts containing hydrogenation metals, typically belonging to Groups 6, 8, 9 and 10 of the Periodic Table (based on the 1990 IUPAC system wherein the columns are numbered from 1 to 18) and in the presence of hydrogen at elevated temperatures and pressures to promote molecular cracking and heteroatom removal.

In these processes, the sulfur atoms in the hydrocarbon streams are exposed or separated from the oil and are able to react with hydrogen which is then liberated from the process typically in the form of a hydrogen sulfide gas. In these processes, nitrogen is also removed to some extent from the hydrocarbon streams (i.e., “denitrogenation”) and metals (i.e., “demetalization”) are also removed to some extent from the hydrocarbon streams. However, sometimes, nitrogen and/or metals are targeted for removal by “pre-processing” the hydrocarbon streams and removing a portion of the nitrogen and/or metals (which may include some amount of reaction cracking and/or desulfurization) prior to contacting the primary hydrodesulfurization or hydrocracking catalysts. Additionally, in these hydrodesulfurization or hydrocracking processes, some of the larger hydrocarbon molecules are “cracked” into smaller hydrocarbon molecules. This is generally called “cracking” or “conversion” and is a significant part of many of these hydroprocessing processes as this converts heavier, low value petroleum streams, such as gas oils and resids, into higher value products such as transportation fuels, for example, gasolines, jet fuels, and diesels.

However, a major problem facing the industry is that in these processes, a hydrocarbon stream is contacted at relatively high temperatures (typically at least 200 to 300° C. and higher) and pressures generally in excess of about 400 psig, and commonly in excess of 1000 psig or even 2500 psig. Hydrogen is commonly utilized in these processes, typically in the range of about 350 to about 2200 psia hydrogen partial pressure. These severe conditions (i.e., high pressures and temperatures) under which these processes operate result in high energy costs as well as significant capital equipment costs being associated with both the construction and operation of these units. Additionally, elevated safety concerns of these operations also result in highly specialized and costly safety, environmental and mitigation controls being associated with these operations. What is needed by the industry is a process which can achieve comparable hydrodesulfurization and/or conversion of petroleum oils at less severe operating conditions than the conventional hydroprocessing processes in the art.

An alternative modification to conventional hydroprocessing has been proposed in U.S. Pat. Nos. 7,157,401 and 7,387,712 to Purta et al. In these processes, petroleum oils are contacted with interstitial metal hydride (“iMeH”) catalysts under mild conditions for hydrogenation of molecules. In particular, these patents disclose three specific compositions of iMeHs disclosed as Cat 100 (or “AT₅ type”), CAT 200 (or “A₂T₁₄B type”) and CAT 300 (or “A₂T type”). It is shown in these patents that these iMeH catalysts show improved hydrogenation production in the presence of microwaves under mild processing conditions (200° C. at 50 psig). This can be seen in Examples 1 through 7 of U.S. Pat. No. 7,157,401 as well as corresponding data in Tables 1 through 7. However, examples in the same patent illustrating low pressure/low severity hydroprocessing conditions (405° C. at 150 psig) are performed in the presence of a catalyst containing both a noble metal (palladium) as well as a Group 6/10 (molybdenum/nickel) hydrogenation catalyst. These processes are illustrated in Example 8 and corresponding Tables 9 and 10 of U.S. Pat. No. 7,157,401.

However, what has been discovered upon further research is that under high pressure/high severity hydroprocessing conditions of greater than 200° C. and 400 psig hydrogen partial pressure, that the iMeH components disclosed and utilized used in U.S. Pat. Nos. 7,157,401 and 7,387,712 may have a limited hydrogen capacity and that these iMeH components may not perform as effectively in the overall conversion and/or hydrogenation of the hydrocarbon streams when subjected to the typical high pressure/high severity conditions experienced in most commercial refining operations. It also may be that the hydrogenation activity shown in Example 8 of U.S. Pat. Nos. 7,157,401 and 7,387,712 may be significantly due to the content of the Ni/Mo hydrogenation catalyst used in these examples as compared to the hydrogenation activity due to presence of the iMeHs utilized.

Therefore, while these iMeH catalysts of U.S. Pat. Nos. 7,157,401 and 7,387,712 may work to some extent under high pressure/high severity hydroprocessing conditions, better iMeH catalytic materials and associated processes are needed in the art to make hydroprocessing of hydrocarbon streams under these more severe conditions economically attractive and feasible.

### SUMMARY OF THE INVENTION

The current invention embodies catalysts and processes for hydroprocessing a hydrocarbon-containing feedstream to produce a product stream with improved product qualities by utilizing high hydrogen capacity/high hydrogen kinetics interstitial metal hydride (“iMeH”) catalysts under high pressure/high severity conditions. These “improved product qualities” include, but are not limited to increased hydrogenation (or increased hydrogen content by weight), conversion or “cracking to a lower average boiling point conversion, higher API gravity, reduced viscosity, as well as lowered levels of sulfur, nitrogen and metals. The current processes utilize new interstitial metal hydrides which have unexpectedly shown both high hydrogen capacities at elevated temperatures and pressures as well as high hydrogen kinetics for the transfer of hydrogen into and out of the interstitial metal hydrides thereby resulting in processes exhibiting improved performance over the interstitial metal hydrides of the prior art when operated under severe hydroprocessing conditions.

The terms “high pressure/high severity” and “severe” hydroprocessing conditions and/or processes are equivalents as utilized herein and are defined as hydroprocessing processes wherein a hydrocarbon feedstream is contacted with a hydroprocessing catalyst in the presence of hydrogen at process conditions of at least 400 psig and at least 200° C. In embodiments of the present invention, the hydroprocessing catalysts are comprised of a “high severity hydroprocessing iMeH” also referred to as the equivalent herein as “CAT 400 iMeH” compositions. In other preferred embodiments of the present invention, the hydroprocessing catalysts are comprised of a CAT 400 iMeH and at least one Group 6, 8, 9 and/or 10 metal component. In even more preferred embodiments, the combined CAT 400 iMeH/Group 6, 8, 9 and/or 10 hydroprocessing catalyst and hydrocarbon feedstream is subjected microwave or radio frequency energy while under process conditions of least 400 psig pressure at a process temperature of at least 200° C. In even more preferred embodiments of the present invention, the CAT 400 iMeH catalysts, co-catalysts, catalyst systems of the current invention described herein are contacted with a hydrocarbon feedstream under hydroprocessing conditions wherein the pressure in the process is at least 600 psig and at least 200° C., and even more preferably at least 400 psig and at least 300° C. In these processes, it is even more preferred that the hydrogen partial pressure is at least 350 psia and even more preferably at least 500 psia.

A preferred embodiment of the present invention is a catalyst comprised of an interstitial metal hydride having a compositional formula of A₁₋ₓBₓT_{(2-y)±d1}C_{y±d2}, wherein:
A=Nd or Zr; B=at least one of La, Ce, Pr, Gd, Tb, Dy, Er, Ho, Ti and Hf; T=at least one of Fe and V; C=at least one of Cr, Mn, Fe, Co, Ni and Cu; and
x=0.0 to 1.0; and y=0.0 to 2.0; and
d₁=0.00 to 0.2; and d₂=0.00 to 0.2.

In a more preferred embodiment of the catalyst of the present invention the interstitial metal hydride has a hydrogen capacity of at least 0.50 wt % hydrogen based on the weight of the interstitial metal hydride at a temperature of 200° C. and 400 psig, and a hydrogen kinetics rate of at least 0.50 wt % hydrogen/min based on the weight of the interstitial metal hydride, at 400 psig and 200° C. In an even more preferred embodiment, interstitial metal hydride catalyst is part of a co-catalyst which contains at least one transition metal element selected from Mo, W, Fe, Co, Ni, Pd, and Pt.

A preferred embodiment of the present invention is a process utilizing the embodiments of the catalyst of the present invention in a process for upgrading a hydrocarbon feedstream comprised of:

a) contacting a hydrocarbon feedstream with a catalyst comprised of an interstitial metal hydride in the presence of hydrogen at process reaction conditions of at least 200° C. and at least 400 psig; and

b) obtaining an upgraded reaction product stream;

wherein the interstitial metal hydride has a compositional formula of A₁₋ₓBₓT_{(2-y)±d1}C_{y±d2}, wherein:
A=Nd or Zr; B=at least one of La, Ce, Pr, Gd, Tb, Dy, Er, Ho, Ti and Hf; T=at least one of Fe and V; C=at least one of Cr, Mn, Fe, Co, Ni and Cu; and
x=0.0 to 1.0; and y=0.0 to 2.0; and
d₁=0.00 to 0.2; and d₂=0.00 to 0.2.

More preferably, the process is performed in the presence of a hydrogen-rich gas containing at least 50 mol % hydrogen, and even more preferably, the process reaction conditions of are least 200° C. and at least 600 psig, and the hydrogen partial pressure during the process reaction is at least 500 psia to produce an upgraded reaction product stream.

In another preferred embodiment of the process of the present invention, the interstitial metal hydride catalyst is a co-catalyst and the co-catalyst contains at least one transition metal element selected from Mo, W, Fe, Co, Ni, Pd, and Pt. In another even more preferred embodiment of the process, the transition metal element is in the sulfided metal condition.

In another preferred embodiment of the process of the present invention, the hydrocarbon feedstream and interstitial metal hydride are further subjected to radio frequency energy or microwave frequency energy while under the reaction conditions.

### BRIEF DESCRIPTION OF THE FIGURES

FIG. 1 is a graph comparing the hydrogen storage capacities and hydrogen kinetics rates of the iMeHs of the prior art (CAT 100, 200, and 300) to those of the high severity hydroprocessing iMeHs (CAT 400 compositions) of the present invention at conditions of 200° C. and 400 psig.

FIG. 2 is a graph comparing the relative first order rate constants of the iMeHs of the prior art (CAT 100, 200, and 300) to those of the high severity hydroprocessing iMeHs (CAT 400 compositions) of the present invention at conditions of 200° C. and 400 psig.

FIG. 3 is a schematic of a preferred reaction process configuration using the iMeH catalysts of the present invention.

FIG. 4 is a graph of the Pressure-Composition-Temperature (“PCT”) curve for a CAT 100 sample of the prior art at various temperatures as described in Example 2 herein.

FIG. 5 is a graph of the Pressure-Composition-Temperature (“PCT”) curve for a CAT 200 sample of the prior art at various temperatures as described in Example 2 herein.

FIG. 6 is a graph of the Pressure-Composition-Temperature (“PCT”) curve for a CAT 300 sample of the prior art at various temperatures as described in Example 2 herein.

FIG. 7 is a graph of the Pressure-Composition-Temperature (“PCT”) curve for a CAT 400 sample of the present invention at various temperatures as described in Example 2 herein.

FIG. 8 is a graph of the hydrogen absorption kinetics test data for CAT 400.

### DETAILED DESCRIPTION OF THE INVENTION

The current invention embodies processes for hydroprocessing a hydrocarbon-containing feedstream to produce a product stream with improved product qualities by utilizing novel high severity hydroprocessing interstitial metal hydride (“iMeH”) catalysts under high pressure/high severity hydroprocessing conditions. These “improved product qualities” include, but not limited, to increased hydrogenation (or increased hydrogen content by weight), lower average boiling point conversion (or “cracking”), higher API gravity, reduced viscosity, and lower levels of sulfur, nitrogen, and metals. The current processes utilize these new “high severity hydroprocessing” interstitial metal hydride catalysts which have unexpectedly shown improved hydrocarbon conversion performance over the interstitial metal hydrides of the prior art under severe hydroprocessing conditions. The terms “high pressure/high severity” and “severe” hydroprocessing conditions and/or processes are equivalents as utilized herein and are defined as hydroprocessing processes wherein a hydrocarbon feedstream is contacted with a hydroprocessing catalyst in the presence of hydrogen under conditions of at least 400 psig pressure at a process temperature of at least 200° C.

It should be noted here that the terms “hydrocarbon-containing stream”, “hydrocarbon stream” or “hydrocarbon feedstream” as used herein are equivalent and are defined as any stream containing at least 75 wt % hydrocarbons. These hydrocarbon feedstreams may be comprised of either “petroleum-based hydrocarbons”, “biofuel hydrocarbons”, or combinations thereof. The “petroleum-based hydrocarbons” are hydrocarbons obtained or derived hydrocarbonaceous materials from geological formations such as, but not limited to, crude oils, and oils derived from coal, tar sands, or bitumens, as well as any intermediate hydrocarbon or final hydrocarbon product derived from these sources. These are generally considered as non-renewable hydrocarbon sources.

As used herein, the terms “heavy hydrocarbon” or “heavy hydrocarbon stream” are equivalent and are defined herein as a subset of “petroleum-based hydrocarbons” and include hydrocarbon-containing streams containing at least 75 wt % hydrocarbons and having an API gravity of less than 20. Preferred heavy hydrocarbon streams for use in the present invention include, but are not limited to low API gravity, high sulfur, high viscosity crudes; tar sands bitumen; liquid hydrocarbons derived from tar sands bitumen, coal, or oil shale; as well as petrochemical refinery heavy intermediate fractions, such as atmospheric resids, vacuum resids, and other similar intermediate feedstreams and mixtures thereof containing boiling point materials above about 343° C. (650° F.). Heavy hydrocarbon streams may also include a blend of the hydrocarbons listed above with lighter hydrocarbon streams for control of certain properties for transport or sale, such as, but not limited to fuel oils and crude blends.

As used herein, the term “biofuel hydrocarbons” or “biofuels” are equivalent and are a sub-set of hydrocarbon streams, and are defined as hydrocarbon-containing streams wherein at least 50 wt % of the hydrocarbon material in the hydrocarbon-containing stream is derived from renewable biomass resources. These biomass resources include any plant or animal derived organic matter, such as dedicated energy crops and trees, agricultural food and feed crops, agricultural crop wastes and residues, wood wastes and residues, aquatic plants, algae, fungi, plant oils, animal oils, animal tissues, animal wastes, municipal wastes, and other waste materials. Biofuels may include, but are not limited to hydrocarbons in the middle distillate range, diesels, kerosenes, gasoline, gasoline fractions, biodiesel, biojet fuel, biogasolines and combinations thereof.

As used herein, the term “plant oil” is a subset of biofuels and is defined as a hydrocarbon-containing material derived from plant sources, such as agricultural crops and forest products, as well as wastes, effluents and residues from the processing of such materials. Plant oils may include vegetable oils. Examples of plant oils may include, but are not limited to, canola oil, sunflower oil, soybean oil, rapeseed oil, mustard seed oil, palm oil, corn oil, soya oil, linseed oil, peanut oil, coconut oil, corn oil, olive oil, and combinations thereof.

As used herein, the term “animal oil” is a subset of biofuels and is defined as a hydrocarbon-containing material derived animal sources, as well as wastes, effluents and residues from the processing of such materials. Examples of animal oils may include, but are not limited to, animal fats, yellow grease, animal tallow, pork fats, pork oils, chicken fats, chicken oils, mutton fats, mutton oils, beef fats, beef oils, and combinations thereof.

In the current invention, new “high severity hydroprocessing iMeHs” are utilized that provide significantly improved hydroprocessing of hydrocarbon streams at elevated pressures and temperatures. U.S. Pat. Nos. 7,157,401 and 7,387,712 to Purta et al, which are herein incorporated by reference, disclose hydroprocessing processes utilizing iMeH catalysts. In these processes, hydrocarbon streams are contacted with interstitial metal hydride (“iMeH”) catalysts under mild conditions for the hydrogenation of hydrocarbon molecules. In particular, these patents disclose three specific compositions of iMeHs disclosed as Cat 100 (or “AT₅ type”), CAT 200 (or “A₂T₁₄B type”) and CAT 300 (or “A₂T type”).

What has been discovered is that these iMeH catalysts of the prior art, while beneficial in the hydroprocessing of hydrocarbon streams, have either a limited hydrogen capacity at elevated temperature and pressure conditions and/or a limited hydrogen kinetics rate for the transfer of hydrogen into and out of the iMeH, and therefore possess a limited ability to improve hydrocarbon conversion rates at the high temperature (above 200° C.) and high pressure (above 400 psig) conditions associated with most commercial hydroprocessing processes. It is now believed that the performance of these iMeHs under severe hydroprocessing conditions is dependent at least in part upon both of these characteristics; i.e., 1) the iMeH should have both a significant hydrogen storage capacity under the processing conditions (i.e., the iMeH not be depleted of hydrogen) as well as 2) should have a high hydrogen kinetics rate for the transfer of hydrogen into and out of the iMeH under the hydroprocessing conditions (i.e., be able to move hydrogen in and out of the iMeH at a rapid rate). The importance of these two characteristics together and the function of the iMeH hydrogen transfer kinetics are not obvious in light of the prior art.

What has unexpectedly been discovered herein is new iMeH catalysts and associated processes that possess significant improvements in hydroprocessing of hydrocarbon feedstreams/materials over the prior art. What has been discovered is a new set of “high severity hydroprocessing iMeHs” which are also referred to herein by the equivalent terms of the “CAT 400 iMeH compositions”, “CAT 400 iMeH”, “CAT 400 catalysts”, or simply “CAT 400”. In preferred embodiments of these iMeH compositions, these compositions have a hydrogen capacity of at least 0.50 wt % hydrogen as based upon the weight of the iMeH at conditions of 200° C. and 400 psig, and a hydrogen kinetics rate of at least 0.50 wt % hydrogen/min as based upon the weight of the iMeH at conditions of 200° C. and 400 psig.

As utilized herein, the terms “interstitial metal hydride” or “iMeH” are equivalents and these terms as utilized herein are defined as materials that are composed of alloyed metals combined with atomic hydrogen, wherein the atomic hydrogen is stored interstitially within the metal alloy matrix.

This matrix can have a crystalline or amorphous structure. The iMeH is especially suited to accommodating monatomic hydrogen extracted from molecular hydrogen. The quantity of atomic hydrogen in the interstitial metallic hydrides has a measurable value, which is a function of alloy composition, and operating temperature and hydrogen partial pressure. In an iMeH, the ratio of hydrogen to metal atoms may vary over a range and may not be expressible as a ratio of small whole numbers. The iMeH compounds of the present invention are able to dissociate diatomic hydrogen molecules at the surface into monatomic hydrogen, absorb copious amounts of monatomic hydrogen thus produced into the metal alloy, and desorb the monatomic hydrogen under the appropriate conditions. A heat of absorption is produced when the molecular hydrogen dissociates into atomic hydrogen and the hydrogen atoms position themselves interstitially in the structure of the material. Additional energy at a suitable steady state process temperature and pressure is required for the release of monatomic hydrogen from within the catalyst. This energy can be derived from the process heat of reaction or from external application of energy or both.

Interstitial metal hydrides are produced by preparing samples of the constituent metals in the desired proportions, and combining them and heating them so that they melt together homogeneously to produce a metal alloy. The resulting metal alloy is then exposed to hydrogen at a temperature and pressure characteristic of the alloy so that the metal alloy takes up the hydrogen in monatomic form.

The iMeH materials of the present invention are typically prepared by a volumetric (gas to solid alloy) method at a known temperature and pressure using a stainless steel reactor. The metallic hydride will absorb hydrogen with an exothermic reaction. This hydrogenation process is reversible according to the following chemical reaction schematic:

Metal Alloy+H₂⇄iMeH+Energy

As noted, the hydrogen absorption is accompanied by an exothermic/endothermic exchange of energy. Hydrogen uptake/release is also accompanied by volume expansion/contraction of the iMeH which under certain conditions can be high as about 20 to 25 vol %. During this process, hydrogen atoms will occupy interstitial sites in the alloy lattice. This hydrogen absorption/desorption by an iMeH can be measured and characterized in a Pressure-Composition-Temperature (“PCT”) plot or graph.

The metal alloy from which an iMeH is produced can be prepared by mechanical or induction heated alloying processes. The metal alloy can be stoichiometric or non-stoichiometric. Non-stoichiometric compounds are compounds that exhibit wide compositional variations from ideal stoichiometry. Non-stoichiometric systems contain excess elements, which can significantly influence the phase stability of the metallic hydrides. The iMeH is produced from a metal alloy by subjecting the alloy to hydrogen at a pressure and temperature that is a characteristic of the particular alloy.

As utilized herein, the term “hydrogen capacity” of an iMeH is defined as the absolute difference 1) the amount of hydrogen absorbed in an iMeH material on a mass basis (wt % hydrogen/wt % iMeH) at a specific pressure and temperature and 2) the amount of hydrogen absorbed in an iMeH material on a mass basis (wt % hydrogen/wt % iMeH) at standard pressure and temperature (1 bar @ 25° C.), based on the absorption curve of the PCT.

Hydrogen capacity at a certain pressure and temperature is determined from the volumetric gas sorption method of Pressure-Composition-Temperature (“PCT”) analysis using, for example, a PCTPro-2000 system®, Hy-Energy LLC™, Newark, Calif. The total amount of hydrogen gas absorbed or desorbed by a sample is pressure and temperature dependent and therefore requires precise measurements of both the pressure and temperature. The volumetric approach to PCT measurements consists of adding (or removing) hydrogen at specific temperatures and pressures. The hydrogen capacity at a constant temperature is related directly to pressure change within a calibrated volume containing the sample. The dependence of hydrogen pressure on hydrogen capacity at an operating temperature is reproducible. The accuracy of the capacity data herein utilizing this equipment is within 2% to 5%.

The iMeH catalysts of the present invention can be selected to have a desired lattice structure and thermodynamic properties, such as the applied pressure and temperature at which they can be charged and the operating pressure and temperature at which they can be discharged. These working thermodynamic parameters can be modified and fine tuned by an appropriate alloying method and therefore, the composition of the catalysts can be designed for use in a particular catalytic process.

The terms “interstitial metal hydride” or “iMeH”, when used, are meant to refer solely to the iMeH component or components. The terms “iMeH catalysts” or “iMeH containing catalysts” as used herein are equivalents and are used as a generic term to cover any catalysts (including catalysts consisting of iMeH(s)), co-catalysts, or catalyst systems which are comprised of an iMeH component.

As utilized herein, the terms “hydrogen kinetics”, “hydrogen absorption kinetics”, or “hydrogen kinetics rates” of an iMeH are equivalents and are defined herein the rate of hydrogen absorption (by mass) as a function of time per unit mass of the iMeH. The hydrogen absorption kinetics of the iMeH is measured when the iMeH is in an unoxidized state. At a set temperature and pressure, the iMeH is exposed to a change in hydrogen partial pressure. The time for the iMeH to absorb the hydrogen and come to equilibrium provides the information needed to calculate the kinetics of hydrogen uptake as the wt % hydrogen increase as a function of time. Using the Hy-Energy™ system the kinetics of hydrogen absorption and the hydrogen kinetics rate are reproducible to within 5%_{.}

In particular to this invention are the “high severity hydroprocessing iMeH” or “CAT 400” catalyst compositions. It should be noted that the composition of the CAT 400 elements can be either stoichiometric or non-stoichiometric. The compositional formulations of CAT 400 are shown as follows. It should be noted that when d₁=0 and d₂=0, a stoichiometric composition of CAT 400 is shown.

CAT 400 (Stoichiometric & Non-Stoichiometric Compositions)
AT_{2±d1±d2} Type
Crystal Structure: Compositionally dependent; Cubic Laves phase-C15
(MgCu₂-type) and Hexagonal Laves phase-C14 (MgZn₂-type)
General Formula: A₁₋ₓBₓT_{(2-y)±d1}C_{y±d2}
wherein:
A=Nd or Zr; B=at least one of La, Ce, Pr, Gd, Tb, Dy, Er, Ho, Ti and Hf;
T=at least one of Fe and V; C=at least one of Cr, Mn, Fe, Co, Ni and Cu; and
x=0.0 to 1.0; and y=0.0 to 2.0; and
d₁=0.00 to 0.2; and d₂=0.00 to 0.2

In a preferred embodiment of CAT 400, d₁=0; and d₂=0 (stoichiometric only compositions).

In a preferred embodiment of CAT 400, d₁=0.05 to 0.2; and d₂=0.05 to 0.2 (non-stoichiometric only compositions).

In a preferred embodiment of CAT 400, A=Zr and T=V.

In another preferred embodiment of CAT 400, A=Zr and T=V; x=0.2 to 0.6; and y=0.2 to 0.6.

In another preferred embodiment of CAT 400, A=Zr; B=at least one of Ti and Hf; T=V; C=at least one of Mn and Fe.

In a more preferred embodiment of CAT 400, A=Nd or Zr; B=at least one of La, Ce, Pr, Gd, Tb, Dy, Er, Ho, Ti and Hf; T=at least one of Fe and V; C=at least one of Cr, Mn, Fe, Co, Ni and Cu; x=0.2 to 0.6; and y=0.2 to 0.6.

In an even more preferred embodiment of CAT 400, A=Zr; B=at least one of Ti and Hf; T=V; C=at least one of Mn and Fe; x=0.2 to 0.6; and y=0.2 to 0.6.

In another even more preferred embodiment of CAT 400, A=Zr; B=at least one of Ti and Hf; T=V; C=at least one of Mn and Fe; x=0.2 to 0.6; and y=0.

These CAT 400 iMeHs can be utilized by themselves as an active catalyst or as a co-catalyst with additional catalytic materials. By the term “co-catalyst” as used herein, it is meant that the iMeH component is either made into a catalyst particle along with other catalytic elements(s), or alternatively, one catalyst particle can be comprised of the iMeH component and mixed with a separate catalyst particle comprised of the catalytic elements(s). Preferred catalytic elements include, but are not limited to Group 6, 8, 9 and 10 elements. More preferred catalytic elements for use with the iMeHs of the present invention are Mo, W, Fe, Co, Ni, Pd, Pt, and combinations thereof. The even more preferred catalytic elements for use with the high severity hydroprocessing iMeHs of the present invention are Mo, W, Co, Ni, and combinations thereof. In a most preferred embodiment, the co-catalyst is comprised of a high severity hydroprocessing iMeH of the present invention and Mo. In another most preferred embodiment, the co-catalyst is comprised of a high severity hydroprocessing iMeH of the present invention, Mo, and either Co, Ni or a combination thereof. In the present invention, the “co-catalyst” systems are a preferred embodiment.

The CAT 400 iMeHs of the present invention have a high hydrogen storage capacity and high hydrogen kinetics at the high temperatures and pressures at which most commercial hydroprocessing processes operate. In particular these high severity processes include, but are not limited to, hydrogenation, hydrocracking, hydrodesulfurization, hydrodenitrogenation, and hydrodemetalization processes. The iMeH metals can absorb and release hydrogen in its monatomic state which is more reactive with the hydrocarbons in the process than the diatomic hydrogen typically present in the processes. However, when the monatomic hydrogen is released from the iMeH surface, it is also highly reactive with other monatomic hydrogen in the system. Therefore, it is desired that the additional catalytic elements in the co-catalyst be located in very close proximity to the CAT 400 iMeH to allow the monatomic hydrogen released to react at the active catalytic sites with the hydrocarbon molecules or heteroatoms (such as sulfur, nitrogen, and metals) in the hydrocarbons to form molecular heteroatom compounds (e.g., hydrogen sulfide) that can be easily removed from the hydroprocessed product stream.

The CAT 400 iMeHs of the present invention can be combined with known hydroprocessing catalysts such as noble metals, metal oxides, metal sulfides, zeolitic acid or base sites to further promote hydroprocessing of feedstocks such as organic compounds. These iMeH materials can be combined with other hydroprocessing materials in a variety of ways to build an optimized catalyst for a particular reaction or function. In general, the finer the powders being mixed (e.g. support, iMeH), the higher the surface area and the more intimate the mixing. Key to the processing steps is to minimize the exposure of iMeH to oxygen and/or water vapor at elevated temperatures (above 25° C.) for extended periods of time. Exposure can be minimized by use of desiccants and by blanketing atmospheres of inert gases such as nitrogen and argon. The iMeH is not calcined or subjected to an oxidizing environment at elevated temperatures.

The catalyst can be used in a powder, extrudate, or preformed matrix form based upon the type of reactor design selected (e.g., fluidized bed, fixed bed, catalytic monolith, etc.). The simplest high severity hydroprocessing iMeH catalyst is the iMeH powder itself. In this case the iMeH provides monatomic hydrogen and is the catalyst for hydroprocessing. The iMeH catalysts of the present invention, when used in powder form, may be mixed and dispersed within the feedstock and transported through a reactor (e.g. slurry reactor). After the desired reaction has been catalyzed in the reactor, the iMeH powder can then be separated from the reaction products for reuse.

The CAT 400 iMeH can be combined with a support and optionally other catalytic elements to produce a composite catalyst. The support provides for the physical dispersion of iMeH, providing greater surface area and ease of handling. The support also serves to increase the surface area of the active catalytic elements and thereby increase the process reaction rates. The support can also add acidic or basic sites that can enhance the catalytic activity of other catalyst components or acts as catalysts themselves. The support also serves to disperse the metallic or metal oxide catalytic sites so as to prevent arcing in the presence of a strong electric or magnetic fields that may be used to expedite catalytic action. The catalyst may further comprises a radio frequency or microwave absorber in thermal contact with the interstitial metal hydride. These absorbers are preferably added metal elements or metal compounds with a high dielectric constant.

The CAT 400 iMeH compositions of the present invention can be utilized in a crystalline or amorphous form. The support may be composed of an inorganic oxide, a metal, a carbon, or combinations of these materials. In preferred embodiments of the present invention, the support is comprised of alumina, silica, titania, zirconia, MCM-41 or combinations thereof. The iMeH phases and catalytic elements can be dispersed as mechanically mixed powders, or can be chemically dispersed, impregnated or deposited. When mixed powders are used in the present invention, the powder particle size is controlled to provide a powder that has particles that are small enough to provide suitable surface area and reactivity, but not so fine as to produce significant surface oxidation. Other catalytic elements included in the co-catalyst or catalyst systems of the present invention may be noble metals such as platinum or palladium, Group 6, 8, 9 and 10 metal oxides and/or metal sulfides, and zeolite acid or base sites. A hydroprocessing component and a hydrocracking component used in combination with the CAT 400 iMeH may be one or more of these catalytic elements. Both the combination of an iMeH powder with a support, which can provide an additional catalyst function (i.e. at catalytically active or inert support), or an iMeH dispersed onto a hydroprocessing catalytic powder, can be especially effective for hydrocracking in a fluidized bed or ebullating bed reactor.

The hydrogen atoms occupy interstitial sites in the alloy lattice of the iMeH and the ratio of hydrogen to metal atoms may vary over a range and may not be expressible as a ratio of small whole numbers. The iMeH compositions of the present invention are also able to dissociate diatomic hydrogen molecules at the surface into monatomic hydrogen (i.e., hydrogen atoms), absorb significant amounts of monatomic hydrogen thus produced, and subsequently desorb a portion of the stored monatomic hydrogen under the appropriate conditions.

Regardless of how the CAT 400 iMeH is incorporated into the catalyst, co-catalyst, or catalyst system, it is important that the high severity hydroprocessing iMeH be limited in its exposure to either air and/or water as the iMeH is prone to forming a strong oxide layer when exposed to oxygen sources. This oxygen layer can create a significant barrier on the iMeH surface which limits the transfer of monatomic hydrogen between the feed environment and the iMeH crystal lattice. Exposure to oxygen and water can be minimized by surrounding the catalyst with a blanketing atmosphere such as nitrogen or argon that is pure or has been treated by a dryer or desiccant to remove water content. These inert atmospheres should be utilized in the fabrication, transportation, and reactor loading sequences of the operation to minimize oxidation of the catalysts.

Example 1 herein describes how the prior art CAT 100, 200, and 300 iMeH catalysts as well as the high severity hydroprocessing CAT 400 catalysts of the present invention were fabricated for the performance testing performed as detailed in Examples 2 and 3 herein. Testing was performed as detailed in Example 2 to measure both the hydrogen capacity of the iMeH catalysts as well as the hydrogen kinetics rates of the various iMeHs at pressure and temperature conditions commensurate with high severity hydroprocessing conditions.

Example 2 herein measures and compares the hydrogen storage capacities of the CAT 100, 200, and 300 iMeHs of the prior art to the high severity hydroprocessing CAT 400 iMeHs of the present invention. The catalysts were prepared as described in Example 1 and were tested for hydrogen capacities at 400 psig and 200° C. which are at the lower end severity of most hydroprocessing conditions utilized in petroleum refining such as hydrocracking, hydrodesulfurization, hydrodenitrogenation, and hydrodemetalization processes. The results from this comparative testing are shown in Table 1.

TABLE 1
Interstitial Metal Hydride Hydrogen Capacities

| | Hydrogen Capacity |
|---|---|
| | (wt % hydrogen) |
| iMeH Catalyst ID | at 200° C. and 400 psig |
| CAT 100 (prior art) | 0.19 |
| CAT 200 (prior art) | 0.29 |
| CAT 300 (prior art) | 3.65 ^{a} |
| CAT 400 (present invention) | 1.18 |

^{a} extrapolated from PCT data

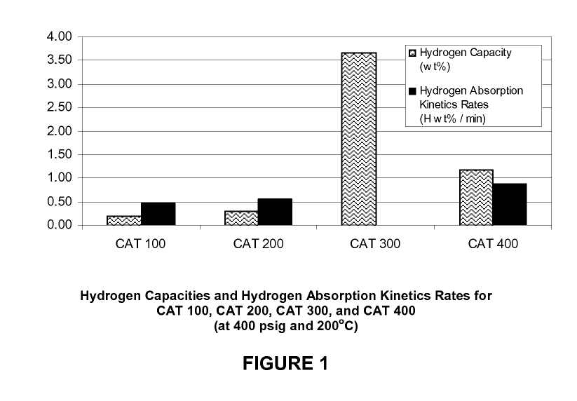

The data from Table 1 is also shown in graphical form in FIG. 1 along with the hydrogen absorption kinetics data from Table 2. As can be seen from Example 2 and the corresponding data in Table 1 and FIG. 1, the CAT 400 iMeH catalysts of the present invention has a hydrogen capacity of greater than 1.0 wt % hydrogen based on the weight of the iMeH. The hydrogen capacity of the CAT 400 is over four (4) times greater (i.e., over 300% improvement) than the capacities of the iMeH catalysts of the prior art under typical hydroprocessing conditions, with the exception of the CAT 300 iMeH, which, as it will be shown later, has separate major deficiencies for use in hydroprocessing of hydrocarbons under severe hydroprocessing conditions.

In contrast with the CAT 100 & 200 iMeHs of the prior art, preferred embodiments of the CAT 400 iMeH catalysts of the present invention have hydrogen capacities of at least 0.50 wt % based on the weight of the iMeH at 400 psig and 200° C., and more preferably the CAT 400 iMeH catalysts of the present invention have hydrogen capacities of at least 1.0 wt % hydrogen based on the weight of the iMeH at 400 psig and 200° C. In a more preferred embodiment of the catalyst of the present invention, the CAT 400 iMeH catalyst is used in a co-catalyst with at least one catalytic element selected from Mo, W, Fe, Co, Ni, Pd, Pt, as well as combinations thereof.

While not wishing to be held to any specific theory, it is believed herein that the hydrogen capacity of the iMeH in hydroprocessing hydrocarbons under severe hydroprocessing conditions is just one important characteristic of a successful iMeH containing hydroprocessing catalyst but success cannot be based on this characteristic alone. In addition to possessing a high storage capacity of hydrogen under the specific operating conditions, it is believed that the iMeH must be able to absorb and desorb (or “shuttle”) hydrogen in and out of the iMeH at a high rate. If this rate is too low or non-existent, then the hydrogen stored in the iMeH is of no or little use to the overall hydroprocessing process. This rate at which the iMeH can absorb hydrogen is referred to herein as the “hydrogen kinetics rate” of the iMeH and its definition and methods of measurements are defined herein.

The testing of Example 2 herein was also utilized to measure and compare the “hydrogen kinetics rates” based on hydrogen absorption of the CAT 100, 200, and 300 iMeHs of the prior art to the CAT 400 high severity hydroprocessing iMeHs of the present invention. The catalysts were prepared as described in Example 1 and were tested in Example 2 for hydrogen kinetics rates at 400 psig and 200° C. which conditions are at the lower end severity of most hydroprocessing conditions utilized in petroleum refining such as hydrocracking, hydrodesulfurization, hydrodenitrogenation, and hydrodemetalization processes. Additional details on the method of testing and measurement of the hydrogen kinetics rates are described in Example 2 herein. The results from this comparative testing are shown in Table 2.

TABLE 2
Interstitial Metal Hydride Hydrogen Kinetics Rates

| | Hydrogen Kinetics Rates |
|---|---|
| | (wt % hydrogen/min) |
| iMeH Catalyst ID | at 200° C. and 400 psig |
| CAT 100 (prior art) | 0.464 |
| CAT 200 (prior art) | 0.555 |
| CAT 300 (prior art) | below detection limits |
| CAT 400 (present invention) | 0.885 |

The data from Table 2 is also shown in graphical form in FIG. 1 along with the hydrogen capacity data from Table 1. As can be seen from Example 2 and the corresponding data in Table 2 and FIG. 1, the CAT 400 iMeH catalyst possesses hydrogen kinetics rates of greater than 0.75 wt % hydrogen/min based on the weight of the iMeH.

As can be seen by reviewing the data shown Tables 1 and 2 together (shown graphically in FIG. 1), while the CAT 100 and 200 iMeHs of the prior art have reasonable hydrogen kinetics rates (as shown in Table 2), they lack any sufficient hydrogen storage capacity (as shown in Table 1) at severe hydroprocessing conditions. Additionally it can be seen by reviewing the data shown Tables 1 and 2 together (shown graphically in FIG. 1), that while the CAT 300 iMeH of the prior art has a reasonable hydrogen storage capacity (as shown in Table 1), it has almost no hydrogen kinetics activity (as shown in Table 2), and therefore almost no ability to shuttle hydrogen at severe hydroprocessing conditions. This lack of simultaneously possessing both significant hydrogen storage capacity and significant hydrogen kinetics in the iMeHs of the prior art renders them significantly deficient for use under the hydroprocessing conditions experienced in most high pressure/high severity commercial applications as compared to the CAT 400 iMeH compositions of the present invention.

In contrast with the CAT 100, 200 and 300 iMeHs of the prior art, preferred embodiments of the CAT 400 iMeH catalysts of the present invention possess both hydrogen capacities of at least 0.50 wt % based on the weight of the iMeH at 400 psig and 200° C., and hydrogen kinetics rates of at least 0.50 wt % hydrogen/min based on the weight of the iMeH, at 400 psig and 200° C. Even more preferably, the CAT 400 iMeH catalysts of the present invention possess both hydrogen capacities of at least 0.75 wt % based on the weight of the iMeH at 400 psig and 200° C., and hydrogen kinetics rates of at least 0.75 wt % hydrogen/min based on the weight of the iMeH, at 400 psig and 200° C. In even more preferred embodiments of the present invention, the CAT 400 iMeH catalysts possess both hydrogen capacities of at least 1.0 wt % based on the weight of the iMeH at 400 psig and 200° C., and hydrogen kinetics rates of at least 0.75 wt % hydrogen/min based on the weight of the iMeH, at 400 psig and 200° C. As noted prior, both of these characteristics, i.e., hydrogen capacity and hydrogen kinetics rates, are believed to be important factors in the performance of the iMeH in hydroprocessing hydrocarbon compounds under severe hydroprocessing conditions. This is illustrated by the testing the various iMeHs under severe hydroprocessing conditions as detailed in Example 3.

Example 3 herein illustrates that the properties of the CAT 400 iMeH catalysts of the present invention possess improved hydroprocessing performance under high severity hydroprocessing conditions. In this example, each of the prior art iMeH catalysts (CAT 100, 200, and 300) and an embodiment of the CAT 400 iMeH catalyst of the present invention were tested under similar hydroprocessing conditions of 400 psig and 200° C. The data is presented as the relative first order rate constant based on the disappearance of reactants expressed as the first order rate constant for each of the model compounds dibenzothiophene, diethyl-dibenzothiophene (4,6-diethyl-dibenzothiophene), and dodecyl-naphthalene (1-n-dodecylnaphthalene). For continuous flow operation units as used in commercial practice, a greater relative first order rate constant translates into higher capacities for given process equipment sizes, or can result in smaller required equipment and lower operating costs.

The first order rate constant is calculated by the formula:

First Order Rate Constant=space velocity×ln(reactant concentration in feed/reactant concentration in the product)

The first order rate constant data obtained has been normalized to shown the relative first order rate constants which are shown in Table 3 and are based on the actual first order rate constant for each model compound for each iMeH tested divided by the actual first order rate constant for each model compound for the CAT 100 iMeH being used a “standard”. Therefore, all of the relative first order rate constants for each model compound tested for CAT 100 are valued at 1.00 and all relative first order rate constants for each model compound for the other iMeHs are shown as relative to CAT 100.

As can be seen in Table 3, the iMeHs of the present invention (CAT 400) have significantly higher relative rate constants as compared to the iMeHs of the prior art (CAT 100, CAT 200, and CAT 300) for all three of the model compounds.

TABLE 3
Relative First Order Rate Constants for Model Compounds
(at 400 psig and 200° C.)

| | | Relative First Order | Relative First Order |
|---|---|---|---|
| | Relative First Order | Rate Constant | Rate Constant |
| | Rate Constant | (Diethyl- | (Dodecyl- |
| iMeH Catalyst ID | (Dibenzothiophene) | Dibenzothiophene) | Naphthalene) |
| CAT 100 (prior art) | 1.00 | 1.00 | 1.00 |
| CAT 200 (prior art) | 0.32 | 0.67 | 0.83 |
| CAT 300 (prior art) | 1.38 | 1.67 | 0.50 |
| CAT 400 (present invention) | 2.16 | 4.00 | 8.17 |

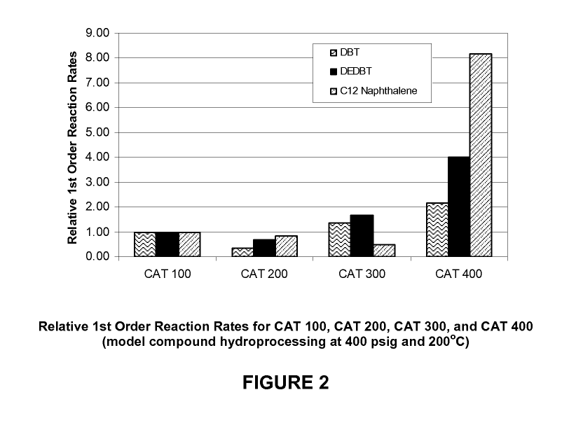

The data from Table 3 is also shown in graphical form in FIG. 2. As can be seen from Example 3 and the corresponding data in Table 3 and FIG. 2, under hydroprocessing conditions, the CAT 400 iMeHs of the present invention possess significantly improved properties to the iMeHs materials of the prior art when utilized in severe hydroprocessing processes for all of the model compounds tested. In particular, it is noted that the first order rate constant for the dodecyl-naphthalene (1-n-dodecylnaphthalene) was over 8 times the first order rate constant of the next highest iMeH (i.e., CAT 100). Since this particular conversion reaction is highly hydrogenation dependent, it shows the significant improved effect of the CAT 400 as a “hydrogen shuttler” in the hydroprocessing reaction as compared to the iMeHs of the prior art.

In preferred embodiments of the present invention, The CAT 400 iMeH catalysts of the present invention possess both hydrogen capacities of at least 0.50 wt % based on the weight of the iMeH at 400 psig and 200° C., and hydrogen kinetics rates of at least 0.50 wt % hydrogen/min based on the weight of the iMeH, at 400 psig and 200° C. More preferably the CAT 400 iMeH catalysts of the present invention have hydrogen capacities of at least 0.75 wt % hydrogen, and hydrogen kinetics rates of at least 0.75 wt % hydrogen/min, based on the weight of the iMeH at 400 psig and 200° C. In another most preferred embodiment, the CAT 400 iMeH catalysts of the present invention have hydrogen capacities of at least 1.0 wt % hydrogen based on the weight of the iMeH at 400 psig and 200° C.

In other embodiments of the CAT 400 iMeH catalysts of the present invention, the iMeH catalysts have hydrogen capacities of at least 0.50 wt % hydrogen, more preferably at least 0.50 wt % hydrogen, and most preferably at least 1.0 wt % hydrogen, as based on the weight of the iMeH as measured at the pressure and temperature conditions under which the hydroprocessing process operates. In other more preferred embodiments of the CAT 400 iMeH catalysts of the present invention, the iMeH catalysts have hydrogen kinetics rates of at least 0.75 wt % hydrogen/min, and most preferably at least 0.75 wt % hydrogen/min, as based on the weight of the iMeH as measured at the pressure and temperature conditions under which the hydroprocessing process operates.

In other preferred embodiments of the catalyst of the present invention, the CAT 400 iMeH catalyst is used in a co-catalyst with at least one catalytic element selected from Mo, W, Fe, Co, Ni, Pd, Pt, as well as combinations thereof. In a more preferred embodiment the CAT 400 iMeH catalyst is used in a co-catalyst with at least one catalytic element selected from Mo, W, Co, Ni, as well as combinations thereof. The even more preferred catalytic elements for use with CAT 400 in co-catalysts are Mo, W, Co, Ni, and combinations thereof. In a most preferred embodiment, the co-catalyst is comprised of a CAT 400 and Mo. In another most preferred embodiment, the co-catalyst is comprised of a CAT 400, Mo, and either Co, Ni or a combination thereof.

In preferred process embodiments of the present invention, these CAT 400 iMeH catalysts are utilized in a hydroprocessing process wherein the operating (or “reaction”) conditions are at least 400 psig and at least 200° C. More preferred reaction conditions are at least 600 psig and at least 250° C. Preferred hydrogen partial pressures are at least about 350 psia, and even more preferably at least about 500 psia. Most preferably the reaction conditions are within the operating envelope of about 200° C. to about 450° C. with an operating pressure of from about 400 psig to about 2500 psig.

In a preferred embodiment of the present invention, a hydrocarbon stream and/or the heavy hydrocarbon stream containing at least 1 wt % sulfur and more preferably at least 3 wt % sulfur is contacted with a catalyst, co-catalyst, or catalyst system containing a CAT 400 iMeH in the presence of hydrogen at a process conditions of at least 200° C. and at least 400 psig. In other preferred embodiments of the present invention, the hydrocarbon stream and/or the heavy hydrocarbon stream that is desulfurized in the present process contains polycyclic sulfur heteroatom complexes which are difficult to desulfurize by conventional methods.

Although not required for the use of the present invention, the catalytic activity of the high severity hydroprocessing iMeH-containing catalysts of the present invention can be enhanced and controlled by exposing the catalyst to radio frequency (“RF”) energy (about 3×10⁵ Hz to about 3×10⁸ Hz) or microwave energy (about 3×10⁸ Hz to about 3×10¹² Hz), either in the absence of, the presence of, or in sequence with conventional fuel fired heating or resistive heating. The RF or microwave energy can provide for a significant increase in hydroprocessing efficiency in comparison to conventional heating. Furthermore the microwave energy can be modulated and controlled in such a manner as to optimize the reaction exchange of the monatomic hydrogen from the iMeH. In one embodiment of the invention, the iMeH catalyst component is placed in contact with a separate absorber of RF or microwave energy. The separate absorber of RF or microwave energy absorbs the energy and transfers it to the iMeH through thermal conduction or convection, and may be one or more compounds such as silicon carbide, iron silicide, nickel oxide, and tungsten carbide. In another embodiment of the invention, the iMeH component functions as the primary absorber of RF or microwave energy. When used with microwave enhancement, the iMeH component is sufficiently dispersed within the catalyst and feedstock combination to solve the problem of hot spots and arcing generally associated with the introduction of metals into a microwave or RF field.

The selective use of RF or microwave energy to drive the catalytic component of the catalyst aids in the release of the iMeH monatomic hydrogen into the feedstock. It is cost effective to maximize the use of fossil fuels to pre-heat the feedstocks to near reaction temperatures, and use minimum RF or microwave energy to drive and control the hydroprocessing reactions. Ideally there will be a minimized or zero net temperature increase from the RF or microwave energy into the catalyst support or into the feedstock because this energy is primarily targeted into the iMeH to enhance the reaction exchange of monatomic hydrogen. Selective coupling of the RF or microwave energy is accomplished through selection and control of the relative dielectric parameters of the catalyst's components and the feedstock. This results in efficient, economically viable catalytic processes, which are enhanced using microwaves.

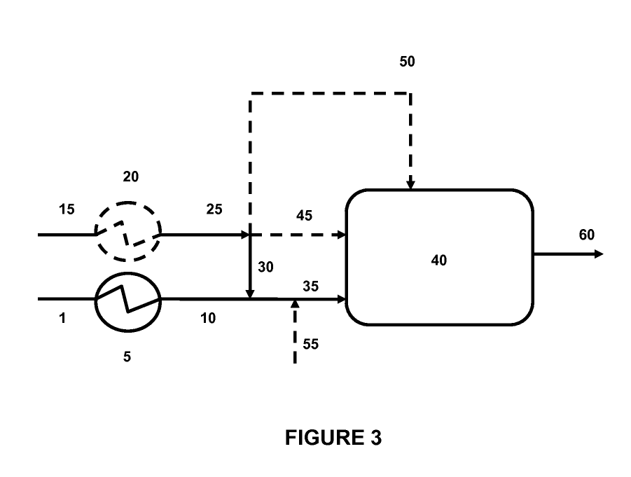

A schematic of a preferred process configuration using the high severity hydroprocessing CAT 400 iMeHs of the present invention is shown in FIG. 3 wherein the incoming hydrocarbon feedstream is heated to a target temperature prior to entering the reactor and the RF or microwave energy is introduced into the reactor itself. FIG. 3 shows a preferred embodiment of the present invention wherein a single stage reactor unit is utilized. Here, a hydrocarbon stream (1) is heated to a predetermined elevated temperature utilizing a fired heater or heat exchange unit (5) to produce a heated hydrocarbon feedstream (10). Similarly a hydrogen-rich stream (15) can be heated, if necessary, a fired heater or heat exchange unit (20) to produce a heated hydrogen-rich stream (25). The term “hydrogen-rich stream” as used herein is a stream containing at least 50 mole percent (mol %) of hydrogen. In a preferred embodiment, at least a portion of the heated hydrogen-rich stream (25) is combined via (30) with the heated hydrocarbon feedstream (10) to form a heated combined hydrocarbon feedstream (35) which is fed to the hydroprocessing reactor unit (40). In an optional embodiment, some, or all, of the heated hydrogen-rich stream enters directly into the hydroprocessing reactor unit (40) via line (45). Even more preferably, at least some of the heated hydrogen-rich stream (25) is fed to various points (50) within the hydroprocessing reactor unit (40) itself This added hydrogen in the reaction process assists in maintaining a sufficient hydrogen concentration within the reactor itself as well as providing fresh hydrogen for absorption/desorption by the high severity hydroprocessing CAT 400 iMeHs present.

Continuing with FIG. 3, in a preferred embodiment, the high severity hydroprocessing iMeH catalyst, co-catalyst, or catalyst system is substantially maintained in the hydroprocessing reactor unit (40) itself. However, in other embodiments, a portion or all of the high hydrogen capacity iMeH catalyst, co-catalyst, or catalyst system is introduced into the feedstream entering the reactor (55) as a slurry or particulate catalyst. Although the high severity hydroprocessing iMeH catalyst, co-catalyst, or catalyst system is shown entering the feedstream system at point (55), the high severity hydroprocessing iMeH catalyst, co-catalyst, or catalyst system can be entered in to either the hydrocarbon feedstream, the heated hydrocarbon feedstream, and/or the hydrogen-rich stream at any point prior to entering the hydroprocessing reactor unit (40). In a preferred embodiment, RF or microwave energy is supplied to the catalyst/hydrocarbon/hydrogen mixture in the hydroprocessing reactor (40) to assist in promoting the absorption and desorption of the monatomic hydrogen in the iMeHs present. Continuous, pulsed, frequency modulated and/or two or more frequencies of RF or microwave energy may be utilized.

It is preferred the reaction conditions hydroprocessing reactor (40) be at least 200° C. and at least 400 psig. Preferred reaction conditions are at least 250° C. and at least 600 psig. Preferred hydrogen partial pressures are at least about 350 psia, and even more preferably at least about 500 psia. Most preferably the reaction conditions are about 200° C. to about 450° C. with an operating pressure of from about 400 psig to about 2500 psig. A reaction product stream (60) is withdrawn from the hydroprocessing reactor (40). This stream will typically contain some gaseous hydrocarbon products and hydrogen. These gaseous products can be separated by processes known in the art and a hydrocarbon product stream with improved product qualities is retrieved.

Hydroprocessing configurations utilizing the high severity hydroprocessing CAT 400 iMeH catalysts of the present invention, which incorporate additional process stages and hydroprocessing reactors to those described above may be also be used in the processes of the present invention and may also be coupled with interstage and/or inter-reactor separations steps to separate liquid hydrocarbon-containing reaction streams from gaseous hydrocarbon-containing reaction streams and/or to incorporate separation steps for separating the catalysts from the hydrocarbons in order to improve overall selectivity and conversion of the final hydrocarbon products as would be obvious to one of skill in the art in light of the present invention disclosure.

The high severity hydroprocessing CAT 400 iMeH catalysts, co-catalysts and catalyst systems of the present invention can be used in any hydroprocessing process. The term “hydroprocessing” (or equivalent term “hydrotreating”) as used herein is a general term and is defined as all catalytic processes involving hydrogen. This includes the reaction of any petroleum fraction with hydrogen in the presence of a catalyst. This includes processes which remove undesirable impurities such as sulfur, nitrogen, metals, and unsaturated compounds in the presence of hydrogen and a catalyst. Examples include, but are not limited to, hydrogenation, hydrocracking, hydrodesulfurization, hydrodenitrogenation hydrodemetalization, and catalytic hydrodewaxing.

Specific hydroprocessing processes wherein the high severity hydroprocessing CAT 400 iMeH catalysts, co-catalysts and catalyst systems of the present invention can be used include, but are not limited to the following processes as defined:

The term “hydrogenation” as used herein is defined as any process wherein a hydrocarbon feedstream is contacted with a catalyst and hydrogen at an elevated pressure and temperature wherein hydrogen is chemically added to at least a portion of the hydrocarbon compounds in the hydrocarbon feedstream, thereby increasing the hydrogen content of the hydrocarbon compounds. Preferred hydrogenation applications include the hydrogen addition to “unsaturated” olefinic or aromatic hydrocarbon compounds (e.g., olefin hydrogenation or aromatic hydrogenation). Hydrogenation is a subset of hydroprocessing processes.

The term “hydrocracking” as used herein is defined as any process wherein a hydrocarbon feedstream is contacted with a catalyst and hydrogen at an elevated pressure and temperature wherein at least a portion of the hydrocarbon feedstream is converted into lower-boiling point products thereby resulting in an overall lower average boiling point product stream based on wt %. Hydrocracking is a subset of hydroprocessing processes.

The term “hydrodesulfurization” or “HDS” as used herein is defined as a process in which a hydrocarbon feedstream is contacted with a catalyst and hydrogen at an elevated pressure and temperature wherein at least a portion the sulfur elements or compounds present in hydrocarbon feedstream are removed thereby resulting in at least one hydrocarbon product with a lower sulfur content than the hydrocarbon feedstream. Hydrodesulfurization is a subset of hydroprocessing processes.

The term “hydrodenitrogenation” or “HDN” as used herein is defined as a process in which a hydrocarbon feedstream is contacted with a catalyst and hydrogen at an elevated pressure and temperature wherein at least a portion the nitrogen elements or compounds present in hydrocarbon feedstream are removed thereby resulting in at least one hydrocarbon product with a lower nitrogen content than the hydrocarbon feedstream. Hydrodenitrogenation is a subset of hydroprocessing processes.

The term “hydrodemetalization” or “HDM” as used herein is defined as a process in which a hydrocarbon feedstream is contacted with a catalyst and hydrogen at an elevated pressure and temperature wherein at least a portion the metal elements or compounds present in hydrocarbon feedstream are removed thereby resulting in at least one hydrocarbon product with a lower metal content than the hydrocarbon feedstream. Hydrodemetalization is a subset of hydroprocessing processes.

The term “catalytic hydrodewaxing” as used herein is defined as a catalytic hydrocracking process which uses molecular sieves, preferably zeolites, to selectively hydrocrack and/or isomerize waxes (i.e., long chain paraffinic molecules with greater than about 22 carbon molecules) present in the hydrocarbon streams to smaller carbon content molecules thereby resulting in an overall lower average boiling point product stream based on wt %. Catalytic hydrodewaxing is a subset of hydroprocessing processes.

Although the present invention has been described in terms of specific embodiments, it is not so limited. Suitable alterations and modifications for operation under specific conditions will be apparent to those skilled in the art. It is therefore intended that the following claims be interpreted as covering all such alterations and modifications as fall within the true spirit and scope of the invention.

### EXAMPLES

### Example 1

This example describes how the CAT 400 high severity hydroprocessing iMeH catalysts of the current invention, as well as the CAT 100, CAT 200, and CAT 300 iMeH catalysts of the prior art were fabricated. These catalysts were utilized for the performance testing described in Examples 2 and 3 herein.

### Chemical Composition of Tested Materials

The chemical compositions of the iMeHs tested in the Examples were as follows:
CAT 100=Mm_{1.1}Ni_{4.22}Co_{0.42}Al_{0.15}Mn_{0.15}
CAT 200=Nd_{2.05}Dy_{0.25}Fe₁₃B_{1.05}
CAT 300=Mg_{1.05}Ni_{0.95}Cu_{0.07}
CAT 400=ZrV₂
   Sample Preparation for the CAT 400 High Severity Hydroprocessing iMeHs of the Present Invention

The metal alloys based on zirconium-vanadium were prepared by melting together the appropriate stoichiometric amounts of metals with purity of 99.9% (from Alfa Aesar/Johnson Matthey Company™) in an argon atmosphere using water cooled copper hearth argon arc furnace Model CENTORR® from Centorr Vacuum Industries™, Nashua, N.H. Each arc-melted ingot was flipped over and re-melted three times and was normally held in the liquid state for approximately 30 seconds to insure complete mixing of the starting materials. The reduction in the sample weight was negligible.

To obtain single phase materials the cast samples were sealed in quartz tubes, filled with ⅓ atmosphere of argon gas and annealed at 950° C. for a period of 3 to 5 days using a Thermo scientific Lindberg/Blue™ tube furnace. The samples in the tubes were water quenched to avoid a possible phase transition during the cooling process.

The crystal structure of the CAT 400 samples was determined by powder X-ray diffraction. The crystal structure was determined to be single phase with cubic Laves phase C15 (MgCu₂) type for ZrV₂ alloys.

Sample Preparation for the CAT 100, CAT 200, and CAT 300 iMeHs of the Prior Art

The preparation of these metal alloys (CAT 100, CAT 200, CAT 300), annealing process and XRD measurement followed the same methods as described above for the CAT 400 preparation.

CAT 100 is based on Mm (Ni, Co, Al, Mn)₅ with a purity of approximately 99.5% for Mm (mischmetal or mixed rare earth), and about 99.9% for Ni, Co, Al and Mn. The weight losses due to evaporation of the Mm elements during the melting were compensated by starting with an excess of approximately 3 wt % of Mm. The crystal structure was determined to be hexagonal with CaCu₅ type.

CAT 200 is based on NdFeBDy with a purity of approximately 99.9%. The weight loss for Nd, Dy during melting was approximately 3%. The crystal structure is tetragonal with Nd₂Fe₁₄B type.

CAT 300 is based on Mg₂NiCu with a purity of about 99.9%. Due to high volatility of Mg the weight loss was about 10%. Excess Mg is added to allow for this loss. The crystal structure is cubic with MoSi₂ type.

### Sample Preparation and Activation

The metal alloy bulk was crushed manually to an average particle size of approximately 200 μm (microns). The hard alloy samples were milled mechanically at cryogenic temperatures (approximately 80° K) and then were attrited. All samples were sieved to under approximately 200 μm (microns).

All particle size preparations of the samples were performed under inert nitrogen atmosphere conditions. The average particle size distribution was obtained using Horiba Laser-La-920® Particle Analyzer, from HORIBA Instruments™, Inc., Irvine, Calif.

Approximately 4 to 5 grams of metal alloy powder with known molecular weight was then placed into the stainless steel reactor connected to the Hy-Energy™ system. The reactor was then purged with hydrogen three times. H₂ pressure is introduced to the sample chamber from about 500 psig to about 800 psig at ambient temperature (i.e., 25° C.) and a waiting period is given to observe if any absorption takes place. A pressure drop in the reactor, generally in the range of about 20 psig depending on the amount of hydrogen absorbed, will indicate the hydrogen activation process. Typical waiting period times are from 10 to 30 minutes. If no absorption occurs, then the temperature is raised to about 250° C. The temperature needed to activate the sample depends on the active surface of the alloy. The sample starts absorbing hydrogen which is an exothermic process. The hydrogen activated sample is then cooled down to ambient temperature and pressure to achieve maximum hydrogen absorption.

To start the Pressure-Composition-Temperature process, the reactor unit is evacuated by pumping out the gas to about 0.1 bar and then heating the sample in the reactor system to approximately 500° C. The period of evacuation depends on the hydride stability of the iMeH used and generally is about 20 to 30 minutes.

The sample is then cooled down to the desired test temperature followed by an absorption PCT run. The sample absorbs hydrogen until equilibrium pressure is reached. The absorption process continues up to the maximum operating pressure of approximately 800 psig. A hydrogen desorption cycle is then started after a complete absorption process cycle.

The difference in the hydrogen capacity for the initial charge and the actual available hydrogen in the metal alloy at a defined temperature and pressure theoretically gives the mole content left in the sample and provides for the calculation of the hydrogen capacity for the iMeH sample at a given pressure and temperature.

### Example 2

The procedures of this example were used to measure the hydrogen capacity of the iMeH catalysts of the prior art (i.e., CAT 100, 200, and 300) and the hydrogen capacity of the “high severity hydroprocessing iMeH” catalysts (i.e., CAT 400). The procedures of this example were also used to measure the hydrogen kinetics rates of the iMeH catalysts of the prior art (i.e., CAT 100, 200, and 300) and the hydrogen kinetics rates of the “high severity hydroprocessing iMeH” catalysts of the present invention (i.e., CAT 400).

### Pressure-Composition-Temperature (“PCT”) Measurement Process

Measurements of Pressure-Composition-Temperature (“PCT”) on the various iMeH samples of Example 1 were performed to determine the hydrogen capacity of the iMeH at several constant temperatures with varying pressures using the fully automated Hy-Energy™ system type PCT-Pro-2000™.

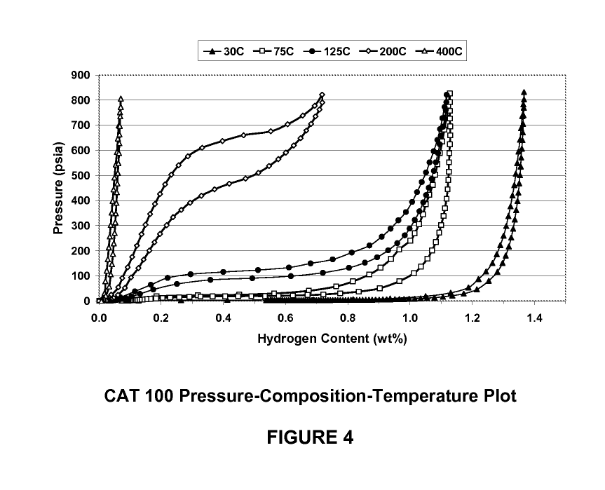

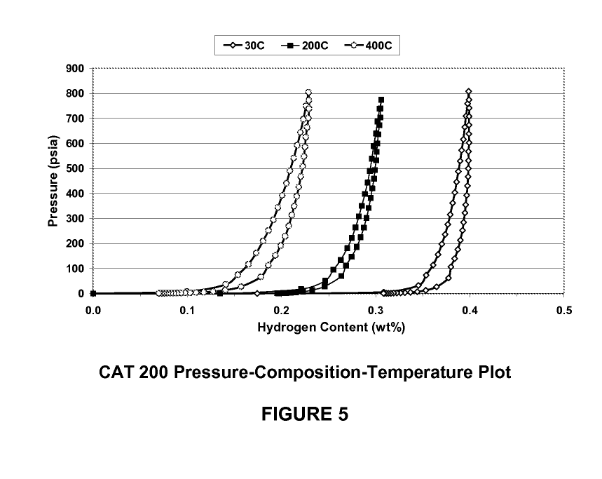

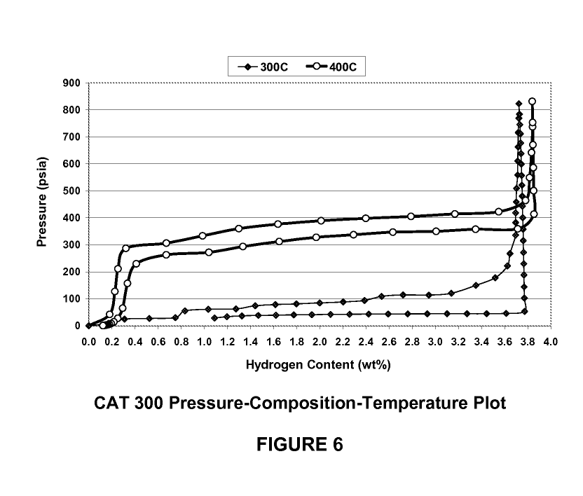

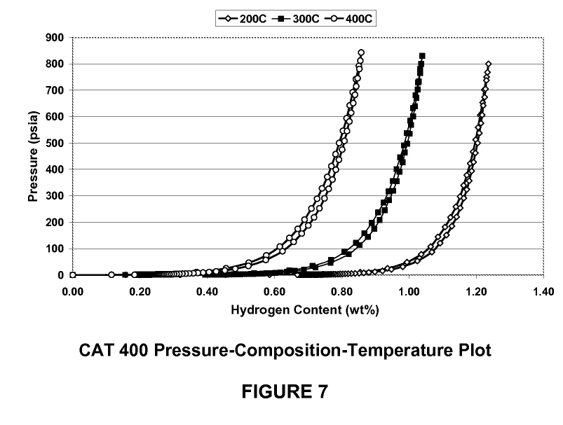

The Pressure-Composition-Temperature (“PCT”) curves generated for each of the four (4) iMeHs tested at various temperatures are shown in FIGS. 4 through 7, corresponding to CAT 100, CAT 200, CAT 300, and CAT 400, respectively. The hydrogen capacities at 400 psig at 200° C. for each of the iMeH samples were drawn from the PCT data from this testing and the results are shown in Table 1.

### Measurement of Hydrogen Kinetics Rates

The kinetics of hydrogen absorption/desorption for iMeH were measured by the following method using the Hy-Energy™ automated system. The methodology and accuracy of the data depend on the operating pressure change for hydrogen absorption/desorption rate as a function of time.

The kinetics test begins by introducing a known reservoir volume of hydrogen into the sample chamber. Hydrogen pressure is monitored to calculate the rate of absorption into the sample (wt % hydrogen or pressure change) versus time. The amount of hydrogen absorbed/desorbed and the pressure change for a complete kinetic cycle is controlled and specified by the Hy-Energy™ unit. The run conditions are selected so the data for the pressure change and its equivalent value of the hydrogen capacity versus time for a cycle (at 200° C.) result in values in the range of interest (i.e. 400 psig).

On the kinetic plot the value of the hydrogen capacity versus time is determined at 95% of the saturation value. This value is reported as the change in hydrogen stored in the hydride (i.e. wt % hydrogen) per unit of time (i.e. minute) for hydrogen absorption at the temperature/pressure conditions.

The hydrogen kinetics testing procedure was performed as follows. A 2 to 5 gram sample of the iMeH powder was placed into the Hy-Energy™ stainless steel reactor. For these tests the iMeH was hand crushed after activating and sieving so particle size was below 200 μm. The system and the sample in the reactor were purged twice with hydrogen gas. The sample temperature was set to 200° C. and allowed to stabilize for 30 to 45 minutes. The sample reservoir volume and the system volume were then calibrated. The programmed cycle life kinetics from the Hy-Energy™ software was selected and run. For absorption tests the delta pressure aliquot was set for 60 Bar with a sample reservoir volume of 4.59 ml. Before running the kinetic test, the sample was prepared by performing three hydrogen kinetic cycles to determine the reproducibility of the data.

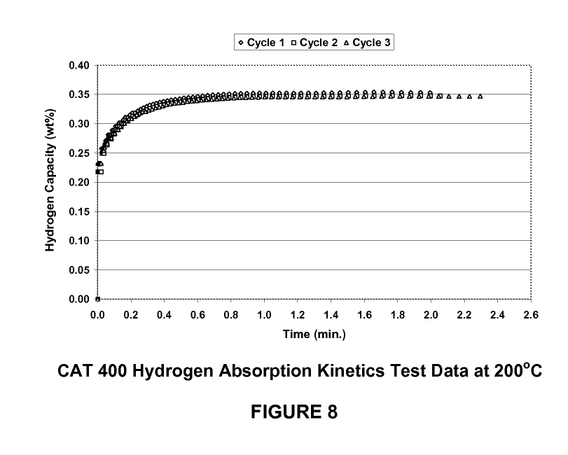

An example of the test data from three hydrogen kinetic cycles at 200° C. for Cat 400 using these test procedures is shown in FIG. 8. For Cat 400, the percent standard deviation for the 95% absorption rate value was ±3.2%, as shown in Table 4.

TABLE 4
CAT 400 Absorption Kinetics Cycle Test Results
(at 400 psig and 200° C.)

| | Stored Hydrogen | | Hydrogen Absorption |
|---|---|---|---|
| | (wt % hydrogen | Time | Kinetics Rate |
| Cycle # | on iMeH) | (minutes) | (wt % hydrogen/min) |
| Cycle 1 | 0.337 | 0.370 | 0.909 |
| Cycle 2 | 0.331 | 0.371 | 0.892 |
| Cycle 3 | 0.330 | 0.386 | 0.854 |
| Average | 0.333 | 0.376 | 0.885 |
| Standard | 0.004 | 0.009 | 0.028 |
| Deviation | | | |
| % Standard | 1.1% | 2.4% | 3.2% |
| Deviation | | | |

The absorption kinetic rate values at 400 psig at 200° C. for each of the for CAT 100, CAT 200, CAT 300, and CAT 400 iMeH samples as measured and determined in this Example are shown in Table 5.

TABLE 5
Absorption Kinetics Test Results
for CAT 100, CAT 200, CAT 300 and CAT 400
(at 400 psig and 200° C.)

| | Mean | | | Hydrogen |
|---|---|---|---|---|
| | Particle | Stored | | Absorption |
| | Size | Hydrogen | | Kinetics Rate |
| | (microns, | (wt % hydrogen | Time | (wt % hydrogen/ |
| iMeH | μm) | on iMeH) | (minutes) | min) |
| CAT 100 | 6.1 | 0.201 | 0.434 | 0.464 |
| CAT 200 | 48.6 | 0.086 | 0.154 | 0.555 |
| CAT 300 | 97.9 | Below detection | — | Below detection |
| | | limits | | limits |
| CAT 400 | 72.1 | 0.333 | 0.376 | 0.885 |

### Example 3

This example calculates and compares the relative first order rate constants (i.e., via measurement and relative comparison of the first order rate constants) of the iMeH catalysts of the prior art (CAT 100, CAT 200, and CAT 300) and the relative first order rate constants of the “high severity hydroprocessing iMeH” catalysts of the present invention (CAT 400) for hydroprocessing (i.e., hydrotreating) model compounds under similar severe hydroprocessing conditions of 200° C. and 400 psig. A mixture of three model compounds was utilized in this testing to observe the conversion rates of typical compounds found in heavy hydrocarbons whose conversion is targeted for product upgrading under hydroprocessing conditions. The testing in this example was performed according to the following procedures.

### Hydrotreating Activity of the Interstitial Metal Hydrides

The reactor testing unit consisted of a multi-well, high-pressure batch reactor that holds 48×3 mL alumina vials. The vials are covered with a plate containing 48 pinholes to allow gas flow into and out of the vials, but limit liquid losses. The iMeH and feed loading and unloading were done in a glove box under nitrogen. The iMeH was added in 32.5 microliter increments to 1.5 mL of feed to simulate space velocity. Mixing was accomplished with an orbital shaker at 300 rpm. A feed mixture containing three model compounds was used for catalyst activity evaluation. The feed mixture was poly alpha olefin based (PAO, 6 centistokes) and spiked with 0.3 wt % dibenzothiophene (DBT), 0.3 wt % 4,6-diethyl-dibenzothiophene (DEDBT), and 1 wt % 1-n-dodecylnaphthalene (C12N). Each reactor was purged with nitrogen and then hydrogen prior to activity testing. The reaction gas was 100% hydrogen. Activity testing was conducted at 200° C. and 400 psig, and held at those conditions for approximately 23 hrs. After which the reactor was cooled to room temperature and purged with nitrogen. Products were removed from the vials and subject to GC analysis.

The relative first order rate constants were then calculated from the results for each of the iMeH samples tested for each of the model compounds (with CAT 100 being used as the relative standard) and the results are presented in Table 3, herein. The relative first order rate constants as shown in Table 3 are based on the actual first order rate constant for each model compound for each iMeH tested divided by the actual first order rate constant for each model compound for the CAT 100 iMeH being used the “standard”. Therefore, all of the relative first order rate constants for each compound for CAT 100 are valued at 1.00 and all relative first order rate constants for each compound for the other iMeHs shown are relative to CAT 100.

The relative first order rate constants from this testing for all of the iMeHs for the three model compounds results are presented in Table 3 and also shown in FIG. 2.

1. A catalyst comprised of an interstitial metal hydride having a compositional formula of A₁₋ₓBₓT_{(2-y)±d1}C_{y±d2}, wherein:
A=Nd or Zr; B=at least one of La, Ce, Pr, Gd, Tb, Dy, Er, Ho, Ti and Hf; T=at least one of Fe and V; C=at least one of Cr, Mn, Fe, Co, Ni and Cu; and
x=0.0 to 1.0; and y=0.0 to 2.0; and
d₁=0.00 to 0.2; and d₂=0.00 to 0.2.

2. The catalyst of claim 1, wherein the interstitial metal hydride has a hydrogen capacity of at least 0.50 wt % hydrogen based on the weight of the interstitial metal hydride at 400 psig and 200° C., and a hydrogen kinetics rate of at least 0.50 wt % hydrogen/min based on the weight of the interstitial metal hydride at 400 psig and 200° C.

3. The catalyst of claim 2, wherein the catalyst further comprises at least one transition metal element selected from Mo, W, Fe, Co, Ni, Pd, and Pt.

4. The catalyst of claim 3, wherein the at least one transition metal element is selected from Mo, W, Co, and Ni.

5. (canceled)

6. The catalyst of claim 1, wherein the interstitial metal hydride and the transition metal element are bound in a matrix comprised of alumina, silica, titania, zirconia, MCM-41 or combinations thereof.)

7. The catalyst of claim 1, wherein d₁=0 and d₂=0.

8. The catalyst of claim 1, wherein d₁=0.05 to 0.2; and d₂=0.05 to 0.2.

9. (canceled)

10. (canceled)

11. (canceled)

12. The catalyst of claim 2, wherein the hydrogen capacity of interstitial metal hydride is at least 1.0 wt % hydrogen based on the weight of the interstitial metal hydride at 400 psig and 200° C.

13. (canceled)

14. The catalyst of claim 1, wherein A=Zr, and T=V.

15. (canceled)

16. (canceled)

17. (canceled)

18. The catalyst of claim 1, wherein A=Zr; B=at least one of Ti and Hf;
T=V; C=at least one of Mn and Fe; x=0.2 to 0.6; and y=0.2 to 0.6.

19. (canceled)

20. A process for upgrading a hydrocarbon feedstream comprised of:
a) contacting a hydrocarbon feedstream with a catalyst comprised of an interstitial metal hydride in the presence of hydrogen at process reaction conditions of at least 200° C. and at least 400 psig; and
b) obtaining an upgraded reaction product stream;
wherein the interstitial metal hydride has a compositional formula of A₁₋ₓBₓT_{(2-y)±d1}C_{y±d2}, wherein:
A=Nd or Zr; B=at least one of La, Ce, Pr, Gd, Tb, Dy, Er, Ho, Ti and Hf; T=at least one of Fe and V; C=at least one of Cr, Mn, Fe, Co, Ni and Cu; and
x=0.0 to 1.0; and y=0.0 to 2.0; and
d₁=0.00 to 0.2; and d₂=0.00 to 0.2.

21. The process of claim 20, wherein the interstitial metal hydride has a hydrogen capacity of at least 0.50 wt % hydrogen based on the weight of the interstitial metal hydride at 400 psig and 200° C., and a hydrogen kinetics rate of at least 0.50 wt % hydrogen/min based on the weight of the interstitial metal hydride at 400 psig and 200° C.

22. The process of claim 21, wherein the catalyst further comprises at least one transition metal element selected from Mo, W, Fe, Co, Ni, Pd, and Pt.

23. (canceled)

24. The process of claim 22, where at least one transition metal element is in the sulfided metal condition.

25. The process of claim 22, wherein process reaction conditions are from are from about 200° C. to about 450° C. and from about 400 psig to about 2500 psig.

26. The process of claim 20, wherein step a) is performed in the presence of a hydrogen-rich gas containing at least 50 mol % hydrogen.

27. (canceled)

28. The process of claim 22, wherein the hydrocarbon feedstream and interstitial metal hydride are further subjected to radio frequency energy or microwave frequency energy while under the reaction conditions.

29. The process of claim 25, wherein the hydrocarbon feedstream is a heavy hydrocarbon feedstream with an API gravity of less than 20 and a sulfur content of at least 1 wt % sulfur.

30. The process of claim 20, wherein the hydrocarbon feedstream is comprised of a biofuel.

31. (canceled)

32. (canceled)

33. (canceled)

34. (canceled)

35. (canceled)

36. (canceled)

37. (canceled)

38. (canceled)

39. (canceled)

40. (canceled)

41. The process of claim 20, wherein A=Zr, and T=V.

42. (canceled)

43. (canceled)

44. (canceled)

45. (canceled)

46. (canceled)
